(19) United States
(12) Patent Application Publication
(10) Pub. No.: US 2022/0075443 A1
(43) Pub. Date: Mar. 10, 2022

(54) REGULATING POWER CORE CONSUMPTION

(71) Applicant: HEWLETT-PACKARD DEVELOPMENT COMPANY, L.P., Spring, TX (US)

(72) Inventors: Robert Lee Crane, 3390 E. Harmony Rd., CO (US); Andrew L. Wiltzius, Fort Collins, CO (US); Jonathan D. Bassett, Fort Collins, CO (US)

(73) Assignee: HEWLETT-PACKARD DEVELOPMENT COMPANY, L.P., Spring, TX (US)

(21) Appl. No.: 17/420,812

(22) PCT Filed: Dec. 14, 2018
(86) PCT No.: PCT/US2018/065725

§ 371 Date: Jul. 6, 2021

(51) Int. Cl. G06F 1/3296; G06F 1/20

(52) U.S. Cl. CPC G06F 1/3296; G06F 1/206

(57) ABSTRACT

A method of regulating power consumption per core within a multi-core package may include estimating power draw for each core within the multi-core processing system. Estimating the power draw for each core within the multi-core processing system may include dividing a total power draw of the multi-core processing system by a number of active cores operating within the multi-core processing system multiplied by a percent utilization of the multi-core processing system. The method may include determining a thermal margin for the multi-core processing system, and instigating a lower power limit for the multi-core processing system in response to a determination that the thermal margin reduces to a predetermined level.

### BACKGROUND

Computing devices are ubiquitous throughout the world. A computing device is a device that can be instructed to carry out sequences of arithmetic or logical operations automatically via computer programming. Modern computing devices have the ability to follow generalized sets of operations, called programs. These programs enable computers to perform an extremely wide range of tasks for a myriad of data processing purposes.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for regulating power consumption per core within a multi-core package, according to an example of the principles described herein.

FIG. 2 is a block diagram of a system for regulating power consumption per core within a multi-core package, according to an example of the principles described herein.

FIG. 3 is a graph depicting the parameters of a multi-core package before implementation of a lower package power limit, according to an example of the principles described herein.

FIG. 4 is a graph depicting the parameters of a multi-core package after implementation of a lower package power limit, according to an example of the principles described herein.

FIG. 5 is a flowchart showing a method of regulating power consumption per core within a multi-core package, according to an example of the principles described herein.

FIG. 6 is a flowchart showing a method of regulating power consumption per core within a multi-core package, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A computing device includes a processing device used to process the data according to a set of operations. A multi-core processor is a single computing component with two or more independent processing units called cores, which read and execute program instructions. The instructions may include central processing unit (CPU) instructions such as, for example, add, move data, and branch. The single processor may run multiple instructions on separate cores at the same time, increasing overall speed for programs amenable to parallel computing. The cores may be integrated onto a single integrated circuit die referred to as a chip multiprocessor or CMP or onto multiple dies in a single chip package.

When an application is executed and is running on fewer than all cores of a multi-core processor, this may cause a relatively higher power density in those cores that are running the application. This, in turn, causes a cooling fan used in active cooling of the cores of the multi-core processor to activate. In some instances, the activation of the cooling fan may produce a loud noise associated with the movement of the fan blades through the air, the mechanical interferences between moving and stationary elements of the fan, and other sources of noise associated with the cooling fan. The speed of rotation, in revolutions per minute (RPM), together with the static pressure may define the airflow for a given fan. Where noise is an issue, larger, slower-turning fans may be quieter than smaller, faster fans that can move the same airflow. However, larger fans take up more space within a computing device, and developers and consumers desire as small of a form factor in a computing device as possible. Cooling fan noise has been found to be roughly proportional to the fifth power of fan speed where halving the speed reduces the noise by about 15 decibels (dB). Axial cooling fans used within computing devices may rotate at speeds of up to around 23,000 rpm. Cooling fans may be controlled by sensors and circuits that variably reduce the fan speed when temperature is not high, leading to quieter operation, longer life, and lower power consumption than fixed-speed fans.

In an example, the processor power may be dynamically adjusted (i.e. lowered) in a situation where the application is executed and is running on fewer than all cores of a multi-core processor. Rather than activate the cooling fan, the processing power may be limited so that the cores within the multi-core processor will maintain the thermal margin established by the vendor or manufacturer of the multi-core processor. However, adjustment of the processing power of the multi-core processor may result in user dissatisfaction in the response time of the computing device since the multi-core processor is not processing at a desired speed.

Examples described herein provide a method of regulating power consumption per core within a multi-core package. The method may include estimating power draw for each core within the multi-core processing system. Estimating the power draw for each core within the multi-core processing system may include dividing a total power draw of the multi-core processing system by a number of active cores operating within the multi-core processing system multiplied by a percent utilization of the multi-core processing system. The method may include determining a thermal margin for the multi-core processing system, and instigating a lower power limit for the multi-core processing system in response to a determination that the thermal margin reduces to a predetermined level.

Estimating power draw for each core within the multi-core processing system may include correlating power consumption of an active core with a detected temperature of the active core. The method may also include dynamically adjusting the power limit for the multi-core processing system until the thermal margin is raised to a predetermined value. Further, the method may include, in response to a determination that the thermal margin or the estimated power draw for each core returns to an acceptable range, increasing the power limit for the multi-core processing system to a default value. The default value may be a thermal design power (TDP) of the multi-core processing system. Further, the default value may be higher than a TDP of the multi-core processing system to maintain performance of the multi-core processing system.

The method may include determining the acceptable range based on hysteresis of the regulation of the power consumption per core. The thermal margin may be set higher than a design limit for all the active cores within the multi-core processing system.

Examples described herein also provide a non-transitory computer-readable medium including a computer-usable program code embodied therewith. The computer-usable program code, when executed by a processor, estimates power draw for each core within the multi-core processing system. Estimating the power draw for each core within the multi-core processing system may include dividing a total power draw of the multi-core processing system by a number of active cores operating within the multi-core processing system multiplied by a percent utilization of the multi-core processing system. The computer-usable program code, when executed by a processor, may also determine a thermal margin for the multi-core processing system, instigate a lower power limit for the multi-core processing system in response to a determination that the thermal margin reduces to a predetermined level, and dynamically adjust the power limit for the multi-core processing system until the thermal margin is raised to a predetermined value.

The computer-readable medium may also include computer-usable program code to, when executed by the processor, increase the power limit for the multi-core processing system to a default value in response to a determination that the thermal margin or the estimated power draw for each core returns to an acceptable range. Further, the computer-readable medium may include computer-usable program code to, when executed by the processor, determine the acceptable range based on hysteresis of the regulation of the power consumption per core. The default value is a TDP of the multi-core processing system. The computer-readable medium may also include computer-usable program code to, when executed by the processor, determine the acceptable range based on hysteresis of the regulation of the power consumption per core.

Examples described herein also provide a system for regulating power consumption per core within a multi-core package. The system may include a power estimation module to estimate power draw for each core within the multi-core processing system. Estimating power draw for each core within the multi-core processing system may include dividing a total power draw of the multi-core processing system by a number of active cores operating within the multi-core processing system multiplied by a percent utilization of the multi-core processing system. The power estimation module may also determine a thermal margin for the multi-core processing system. The system may also include a controller to instigate a lower power limit for the multi-core processing system in response to a determination that the thermal margin reduces to a predetermined level. The controller may dynamically adjust the power limit for the multi-core processing system until the thermal margin raised to a predetermined value, and, in response to a determination that the thermal margin or the estimated power draw for each core returns to an acceptable range, increase the power limit for the multi-core processing system to a default value.

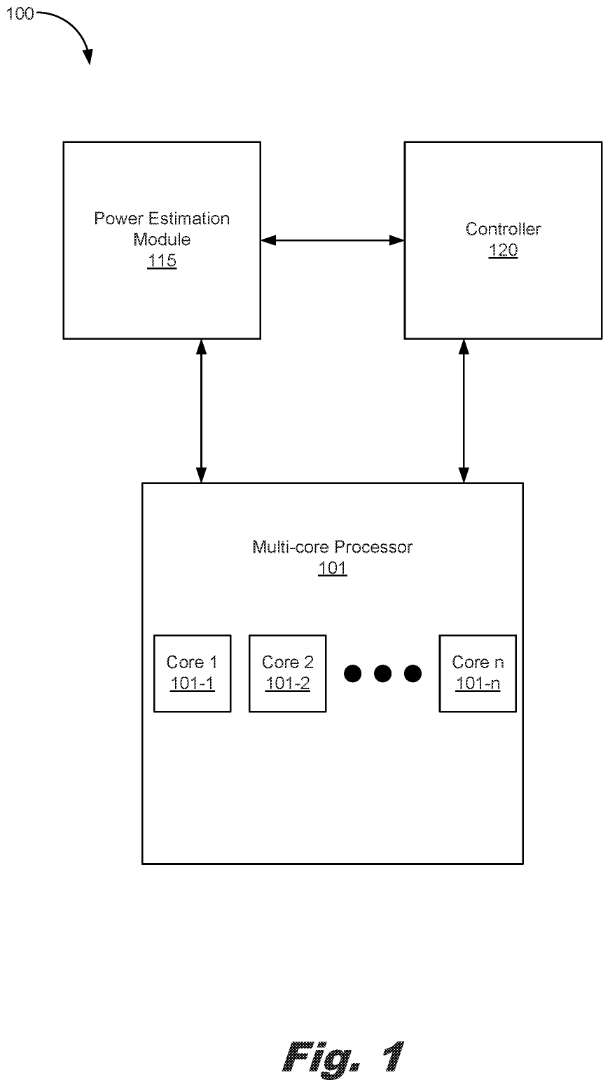

Turning now to the figures, FIG. 1 is a block diagram of a system (100) for regulating power consumption per core (101-1, 101-2, 101-n) within a multi-core package, according to an example of the principles described herein. The system (101) may include a power estimation module (115). The power estimation module (115) estimates power draw for each core (101-1, 101-2, 101-n) within the multi-core processing system (100). Although three cores (101-1, 101-2, 101-n) are depicted in FIG. 1, any number of cores may be present within the multi-core processor (101) with n of 101-n designating any positive integer.

Estimating power draw for each core (101-1, 101-2, 101-n) may include dividing a total power draw of the multi-core processing system (100) by a number of active cores (101-1, 101-2, 101-n) operating within the multi-core processing system (100) to obtain a first value. This first value may be multiplied by a percent utilization of the multi-core processing system (100) to obtain an estimated per-core power consumption. The power estimation module (115) may also determine a thermal margin for the multi-core processing system (100). In one example, the mathematical reciprocal of the estimated per-core power consumption may also be used within the methods described herein in determining when to instigate a lower power limit for the multi-core processing system and when to remove the lower power limit.

The system (100) may also include a controller (120) to instigate a lower power limit for the multi-core processing system (100) in response to a determination that the thermal margin reduces to a predetermined level. The controller (120) may dynamically adjust the power limit for the multi-core processing system (100) until the thermal margin is raised to a predetermined value, and, in response to a determination that the thermal margin or the estimated power draw for each core (101-1, 101-2, 101-n) returns to an acceptable range, may increase the power limit for the multi-core processing system (100) to a default value. In one example, the power limit may be increased in a number of increments up to and, in some examples, beyond the default value. In another example, the power limit may be increased to a value less than PL1 but higher than the lower power limit. In still another example, a combination of these examples may be instigated in controlling the function of the multi-core processing system (100).

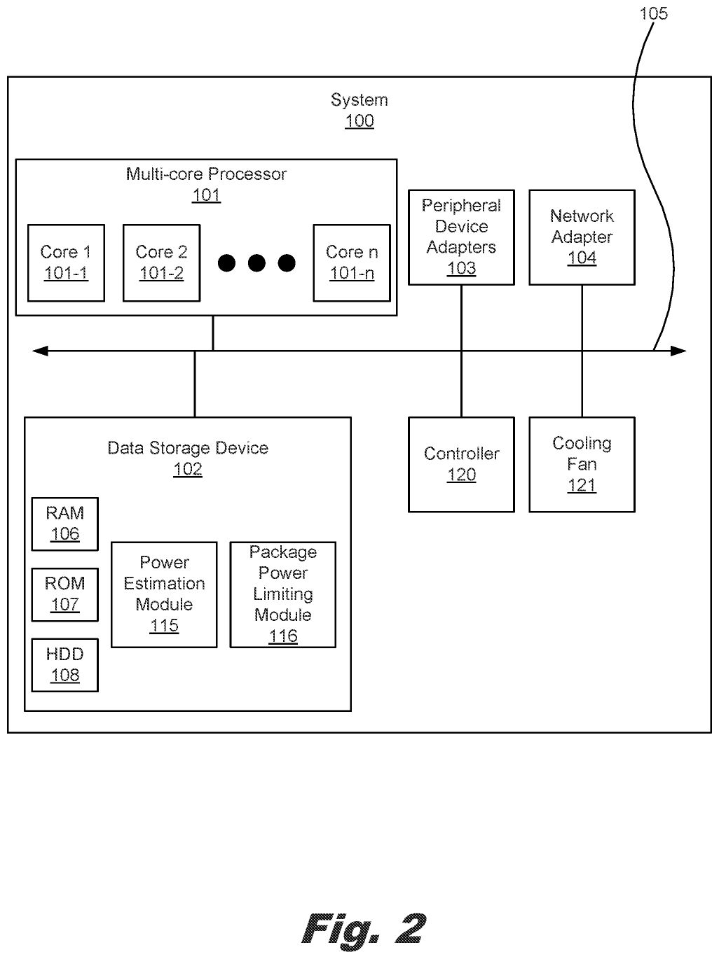

FIG. 2 is a block diagram of a system (100) for regulating power consumption per core within a multi-core package, according to an example of the principles described herein. The system (100) may be implemented in an electronic device. Examples of electronic devices include servers, desktop computers, laptop computers, personal digital assistants (PDAs), mobile devices, smartphones, gaming systems, and tablets, among other electronic devices.

The system (100) may be utilized in any data processing scenario including, stand-alone hardware, mobile applications, through a computing network, or combinations thereof. Further, the system (100) may be used in a computing network, a public cloud network, a private cloud network, a hybrid cloud network, other forms of networks, or combinations thereof. In one example, the methods provided by the system (100) are provided as a service over a network by, for example, a third party. In this example, the service may include, for example, the following: a Software as a Service (SaaS) hosting a number of applications; a Platform as a Service (PaaS) hosting a computing platform including, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the system (100) are executed by a local administrator.

To achieve its desired functionality, the system (100) includes various hardware components. Among these hardware components may be a multi-core processor (101), a data storage device (102), a peripheral device adapter (103), a network adapter (104), a controller (120), and a cooling fan (121). These hardware components may be interconnected through the use of a number of busses and/or network connections such as, for example, via a bus (105).

The multi-core processor (101) may include the hardware architecture to retrieve executable code from the data storage device (102) and execute the executable code. The executable code may, when executed by the multi-core processor (101), cause the multi-core processor (101) to implement at least the functionality of estimating power draw for each core (101-1, 101-2, 101-n) within the multi-core processing system (100) including dividing a total power draw of the multi-core processing system (100) by a number of active cores (101-1, 101-2, 101-n) operating within the multi-core processing system (100) multiplied by a percent utilization of the multi-core processing system (100), determining a thermal margin for the multi-core processing system, instigating a lower power limit for the multi-core processing system in response to a determination that the thermal margin reduces to a predetermined level, and other methods and processes described herein, according to the methods of the present specification described herein. In the course of executing code, the multi-core processor (101) may receive input from and provide output to a number of the remaining hardware units.

The data storage device (102) may store data such as executable program code that is executed by the multi-core processor (101) or other processing device. As will be discussed, the data storage device (102) may specifically store computer code representing a number of applications that the multi-core processor (101) executes to implement at least the functionality described herein. The data storage device (102) may include various types of memory modules, including volatile and nonvolatile memory. For example, the data storage device (102) of the present example includes Random Access Memory (RAM) (106), Read Only Memory (ROM) (107), and Hard Disk Drive (HDD) memory (108). Many other types of memory may also be utilized, and the present specification contemplates the use of many varying type(s) of memory in the data storage device (102) as may suit a particular application of the principles described herein. In certain examples, different types of memory in the data storage device (102) may be used for different data storage needs. For example, in certain examples the multi-core processor (101) may boot from Read Only Memory (ROM) (107), maintain nonvolatile storage in the Hard Disk Drive (HDD) memory (108), and execute program code stored in Random Access Memory (RAM) (106).

All metrics obtained from the multi-core processor (101) and/or its individual cores (101-1, 101-2, 101-n) may be stored in the data storage device (102). The metrics may be obtainable form the cores (101-1, 101-2, 101-n) individually and/or the multi-core processor (101) as a whole. In one example, a series of metrics may be stored in the data storage device (102) in order to use the metrics when considering the dependence of the state of the system (100) throughout its history. In other words, the data stored in the data storage device (102) may be used in the hysteresis processes described herein.

The data storage device (102) may include a computer-readable medium, a computer-readable storage medium, or a non-transitory computer-readable medium, among others. For example, the data storage device (102) may be, but is not limited to, an electronic, magnetic, optical, electromagnetic, infrared, or semiconductor system, apparatus, or device, or any suitable combination of the foregoing. More specific examples of the computer-readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can contain, or store computer-usable program code for use by or in connection with an instruction execution system, apparatus, or device. In another example, a computer-readable storage medium may be any non-transitory medium that can contain, or store a program for use by or in connection with an instruction execution system, apparatus, or device.

The hardware adapters (103, 104) in the system (100) enable the multi-core processor (101) to interface with various other hardware elements, external and internal to the system (100). For example, the peripheral device adapters (103) may provide an interface to input/output devices, such as, for example, a display device, a mouse, or a keyboard. The peripheral device adapters (103) may also provide access to other external devices such as an external storage device, a number of network devices such as, for example, servers, switches, and routers, client devices, other types of computing devices, and combinations thereof. The network adapter (104) may provide an interface to other computing devices within, for example, a network, thereby enabling the transmission of data between the system (100) and other devices located within the network.

The system (100) further includes a number of modules used in the implementation of the methods described herein. The various modules within the system (100) include executable program code that may be executed separately. In this example, the various modules may be stored as separate computer program products. In another example, the various modules within the system (100) may be combined within a number of computer program products; each computer program product including a number of the modules.

The system (100) may include a power estimation module (115) to, when executed by the multi-core processor (101), determine an estimated per-core power consumption of the cores (101-1, 101-2, 101-n) of the multi-core processor (101). The estimated per-core power consumption of the cores (101-1, 101-2, 101-n) is used in the instigation of a lower package power limit among the cores (101-1, 101-2, 101-n) in response to a determination that a thermal margin within the multi-core processor (101) reduces to a set point. In one example, the mathematical reciprocal of the estimated per-core power consumption may also be used within the systems and methods described herein in determining when to instigate a lower power limit for the multi-core processing system and when to remove the lower power limit.

The system (100) may include a package power limiting module (116) to, when executed by the multi-core processor (101), instigate the lower package power limit to cause the thermal margin to dynamically adjust to a positive value or to an acceptable value. The package power limiting module (116) may also check or re-check the thermal margin and the per-core power estimation periodically to determine if the thermal margin or the per-core power estimation falls back into an acceptable range, and may use hysteresis to make such a determination. The package power limiting module (116) may also increase the package power limit to a default value based on the outcome of the previous determinations.

In one example, an application may be written to execute commands sequentially. In this example, at the time of compiling, a single threaded application is created that, at the time of execution, the operating system of the computing device assigns the single-threaded application a thread that is executed on one core (101-1, 101-2, 101-n) of the multi-core processor (101). In another example, multi-threaded applications may be written, and the operating system may schedule the plurality of threads on separate cores (101-1, 101-2, 101-n) within the multi-core processor (101). In still another example, the thread or threads of the application may be requested to run on a specific core (101-1, 101-2, 101-n) or cores (101-1, 101-2, 101-n) of the multi-core processor (101) based on processor affinity. Processor affinity enables the binding and unbinding of a process or a thread to a processor or a range of processors, so that the process or thread will execute on the designated processor or processors rather than any processor. Still further, separate applications may be executed on separate cores (101-1, 101-2, 101-n) such that a first application may be scheduled by the operating system to a first set of cores (101-1, 101-2, 101-n) while a second application may be scheduled by the operating system to a second set of cores (101-1, 101-2, 101-n) where a set of cores (101-1, 101-2, 101-n) includes at least one of the cores (101-1, 101-2, 101-n) of the multi-core processor (101).

Multi-core processor (101) designers and manufacturers may design thermal solutions of for the multi-core processor (101) that allow for all cores (101-1, 101-2, 101-n) to be active at their TDPs. When measuring noise within the computing device produced by the activation of the cooling fan (121), the TDPs and the power level at which each core (101-1, 101-2, 101-n) is operating may be used as an indicator of noise. In situations where fewer than all of the cores (101-1, 101-2, 101-n) within the multi-core processor (101) are operating close to the same total power, an area of the multi-core processor (101) may be difficult to cool.

The multi-core processor (101) utilizes internal metrics to keep track of the states and functions of the multi-core processor (101) including a total package power of the multi-core processor (101) that is a measure of how much total power the entire multi-core processor (101) is consuming including all of the cores (101-1, 101-2, 101-n) of the multi-core processor (101) as well as all of the auxiliary components within the die of the multi-core processor (101). In this example, the total package power metric does not indicate how much power each individual core (101-1, 101-2, 101-n) of the multi-core processor (101) is consuming. This means that the total package power metric may indicate that the total power consumed may be consumed by a single core (101-1, 101-2, 101-n), or multiple cores (101-1, 101-2, 101-n), but the exact power consumed by each core (101-1, 101-2, 101-n) is unknown. Other metrics that the counters are able to obtain includes how many of the cores (101-1, 101-2, 101-n) of the multi-core processor (101) are active, and at what percent utilization each core (101-1, 101-2, 101-n) is being utilized. With these two metrics, it is possible to estimate how the total power consumed is being divided up among the active cores (101-1, 101-2, 101-n). In other words, the metrics obtained from the multi-core processor (101) do not indicate an exact amount of power consumed by each of the cores (101-1, 101-2, 101-n).

Thus, multiplying the total number of cores (101-1, 101-2, 101-n) in the multi-core processor (101) by the percent of the cores (101-1, 101-2, 101-n) that are active or are utilized, and dividing the total power consumed by the multi-core processor (101) by that value provides an estimated per-core power consumption. For example, if 100% of the cores (101-1, 101-2, 101-n) within the multi-core processor (101) were being utilized, then the total power consumed by the number of cores (101-1, 101-2, 101-n) within the multi-core processor (101) would provide the estimated per-core power consumption. In another example, if 25% percent of the cores (101-1, 101-2, 101-n) within the multi-core processor (101) were being utilized, then the estimated per-core power consumption would be the number of cores (101-1, 101-2, 101-n) multiplied by 25% and the total power consumption may be divided by that number. Thus, the lower the utilization of the cores (101-1, 101-2, 101-n) within the multi-core processor (101), the higher the estimation of the per-core power consumption. In one example, the mathematical reciprocal of the estimated per-core power consumption may also be used within the systems and methods described herein in determining when to instigate a lower power limit for the multi-core processing system and when to remove the lower power limit.

In one example, per-core temperatures may also be received as metrics that may be used to compare to the total power consumed to obtain an estimated per-core power consumption value. As the temperature of the cores (101-1, 101-2, 101-n) within the multi-core processor (101) correlate with the total power consumed by the multi-core processor (101), this metric may be used in the same manner as the estimated per-core power consumption.

The thermal margin of the multi-core processor (101) is then checked to determine if the temperature of the multi-core processor (101) is above or below the thermal margin. A positive thermal margin indicates that the multi-core processor (101) is operating at an acceptable temperature based on the manufacturer's specifications, whereas a negative thermal margin indicates that the multi-core processor (101) is operating outside the manufacturer's specifications. Although operation of the multi-core processor (101) outside the thermal margin for a limited amount of time may be acceptable, doing so consistently for an extended amount of time may cause physical damage to the multi-core processor (101). In one example, the multi-core processor (101) may keep track of the thermal margin and instances when the temperature of the multi-core processor (101) is negative or positive. In one example of a cooling strategy, the temperature of the multi-core processor (101) rather than the thermal margin may be considered. In this example, the temperature of the hottest core (101-1, 101-2, 101-n) may be reported as the temperature of the multi-core processor (101).

If the thermal margin reduces to a set point or predefined level such that the thermal margin approaches zero and beings to be negative and outside the manufacturer's specifications (i.e., the temperature of the multi-core processor (101) relatively increases), an action may be taken to cool the multi-core processor (101) including instigating a lower package power limit such that the multi-core processor (101) as a whole is operated at a lower power level or is provided less power. Provisioning less power to the multi-core processor (101) controls the per-core power supplied to the cores (101-1, 101-2, 101-n) of the multi-core processor (101).

In one example, the level of power the multi-core processor (101) is allowed to operate at may be dynamically adjusted until the thermal margin is acceptable or is within an acceptable range. In one example, the acceptable thermal margin may be any thermal margin that approaches zero, and begins to be positive and within the manufacturer's specifications (i.e., the temperature of the multi-core processor (101) relatively decreases). The predefined level associated with the thermal margin may be a level at which the action is taken, and may be, for example, 5° F. of thermal margin.

At the point after the lower package power limit has been instigated and the thermal margin returns to the acceptable level or is within the acceptable range, the thermal margin and the per-core power estimate may be detected again. In response to either the thermal margin or the per-core power estimate falling into an acceptable range, the package power limit of the multi-core processor (101) may be increased between and up to a default value. In one example, the default value may be the TDP of the multi-core processor (101) or another steady state power level that is not exceeded on average over time.

In one example, hysteresis of previous adjustments in the power provided to the multi-core processor (101) may be considered to indicate what an acceptable thermal margin is or what is an acceptable range of the thermal margin. Application of hysteresis allows for the cycling between application of the relatively lower power level to the multi-core processor (101) and a state where the power level is not adjusted to be reduced. In one example where hysteresis is applied, it may be the case that a particular computing device's multi-core processor (101) continually enters a state of high per-core power. In this situation, the lower package power limit may be reduced such that there is less cycling into and out of the lower package power state. Specifically, the package power limit may be lowered such that the lower package power state may remain active longer before the system moves out of the lower package power state. By reducing the number of instances where the multi-core processor (101) moves into and out of the lower package power state, the activation of the cooling fan (121) is reduced which, in turn, reduces the noise produced by the cooling fan (121).

In one example, the per-core power limit may be set slightly above a designed per-core power limit to allow for performance to be as high as possible. The designed per-core power limit at TDP for all cores (101-1, 101-2, 101-n) being active may be set at a first value by, for example, a manufacturer of the multi-core processor (101). In this example, the per-core power limit may be set at a second value relative to the manufacturer's designed per-core power limit. The per-core power limit (i.e., the second value) may be set higher than the manufacturer's designed per-core power limit (i.e., the first value) to keep performance of the multi-core processor (101) as high as possible. In one example, hysteresis may be used to set the second value defining per-core power limit such that past instances where a relatively higher per-core power limit was used successfully may be relied upon as a benchmark as to where the second value defining per-core power limit may be set. In one example, the second value defining per-core power limit may be set between a first limit where hysteresis identifies that the multi-core processor (101) begins to operate too hot and where the multi-core processor (101) begins to operate at too slow a performance level. This allows for the processing of data on fewer than all cores of the multi-core processor (101), but acoustical noise levels from the cooling fan (121) are not an issue and the multi-core processor (101) is not operating at a dangerous or unsatisfactory temperature.

It is possible to operate the multi-core processor (101) above the TDP at, for example, power limit levels such as PL1, PL2 and PL3, among other relatively higher frequency modes. For example, the multi-core processor (101) may be operated at approximately 25% above the TDP (i.e. at PL2) for a certain amount of time such as, for example, up to approximately 28 seconds. Thus, if the multi-core processor (101) includes four cores (101-1, 101-2, 101-n), for example, and three of the four cores (101-1, 101-2, 101-n) are active, the multi-core processor (101) may be able to operate without instigation of the lower package power limit and the power density may still be manageable. However, if the number of cores (101-1, 101-2, 101-n) active drops to two, for example, the power density in a given area of the multi-core processor (101) may increase, and the lower package power limit described herein may be instigated. The thermal margin may function in the same manner wherein if the thermal margin is not within a range where high acoustical levels from the cooling fan (121) are not created, then the thermal margin may be considered acceptable. Thus, an appropriate range of per-core power and thermal margin may be determined before the methods described herein are executed based on the type of multi-core processor (101) being operated.

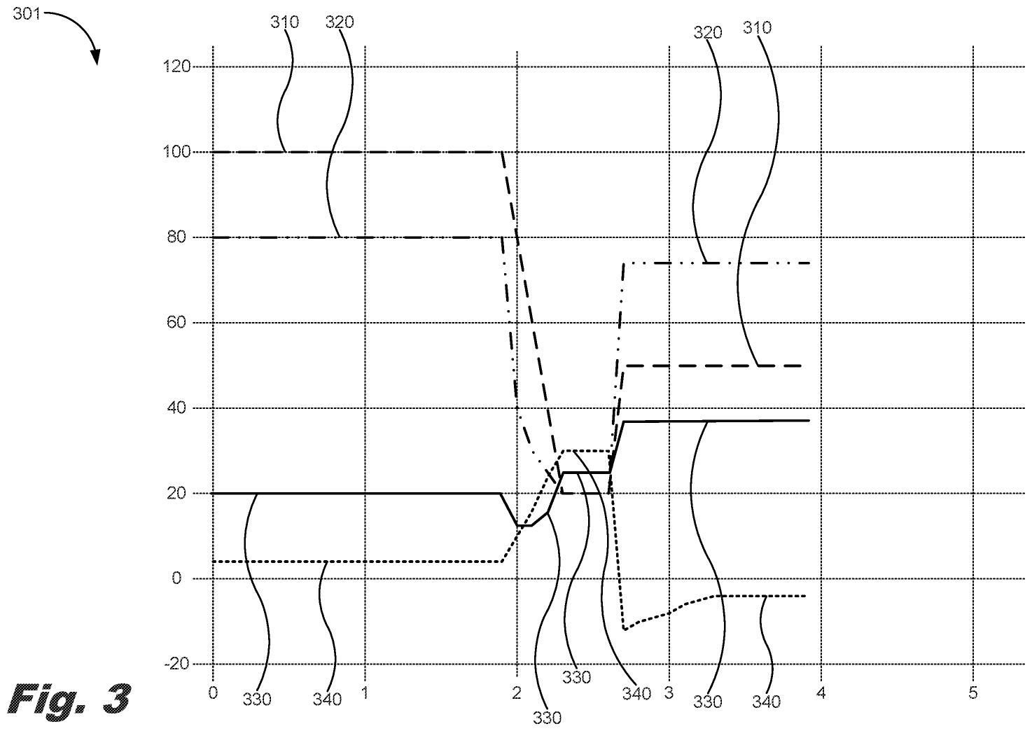

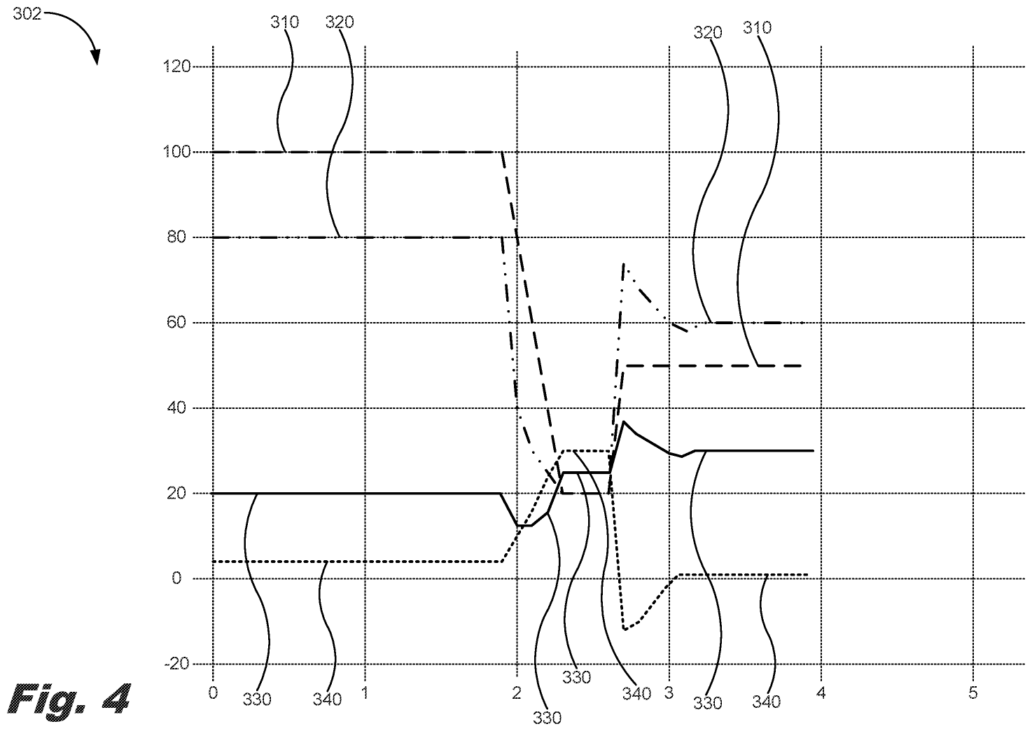

FIG. 3 is a graph (301) depicting the parameters of a multi-core package before implementation of a lower package power limit, according to an example of the principles described herein. Further, FIG. 4 is a graph (302) depicting the parameters of a multi-core package after implementation of a lower package power limit, according to an example of the principles described herein. The charts (301, 302) of FIGS. 3 and 4, respectively were modeled from a multi-core processor (101) with four cores (101-1, 101-2, 101-n). Two of the four cores (101-1, 101-2, 101-n) are active within the multi-core processor (101) in FIGS. 3 and 4. The data modeling depicted in charts (301, 302) of FIGS. 3 and 4 were obtained from a power and thermal modeling program where selection of a number of parameters may be made such as the type of multi-core processor (101) and operating parameters.

As depicted in FIGS. 3 and 4, line (310) is the percentage of core utilization within the multi-core processor (101). Line (320) is the power supplied to the multi-core processor (101) package as measured in watts (W). Further, line (330) is an estimate of per-core power as detected throughout the multi-core processor (101) and is measured in watts. Line (340) is the thermal margin of the multi-core processor (101) as measured in degrees Celsius (° C.). As to line (330) designating the per-core power estimate, the per-core power estimate may begin at approximately 20 W. Thus, running 4 cores (101-1, 101-2, 101-n) of the multi-core processor (101) at 80 W total gives a value of 20 W per-core power estimate. An event occurs at approximately the 2 second mark where 2 of the 4 cores (101-1, 101-2, 101-n) are active instead of 4 as was the case initially. The application modeled as running on the 2 cores (101-1, 101-2, 101-n) is a hot application running at approximately 74 W total resulting in the per-core power estimate shifting to 37 W as indicated at the end of line (330). With fewer than all cores (101-1, 101-2, 101-n) active, the per-core power may be higher than a manufacturer's design goal. The percentage of core utilization indicated by line (310) shifts from 100% (i.e., all 4 cores (101-1, 101-2, 101-n) active) at the outset to 50% (i.e., 2 cores (101-1, 101-2, 101-n) active) after the event. Line 320 indicates that the total package power before the switch from 4 cores (101-1, 101-2, 101-n) active to 2 cores (101-1, 101-2, 101-n) active to be approximately 80 W to 74 W after the switch. It is noted that with 2 cores (101-1, 101-2, 101-n) active, the 74 W total package power (320) is still close to the total power level that may be provided to the multi-core processor (101).

At the beginning of the modeling, the line (340) indicating the thermal margin of the multi-core processor (101) is at approximately 4° C. However, after the change from 4 cores (101-1, 101-2, 101-n) to 2 cores (101-1, 101-2, 101-n) active, the multi-core processor (101) begins to become more difficult to cool, and the thermal margin goes negative ending at approximately −5° C. In this state, the cooling fans (121) are running at full speed in order to cool the multi-core processor (101) due to the high-power density in those cores (101-1, 101-2, 101-n) that are running the application. The cooling fans (121) running at full speed creates the undesirable noise described herein.

Referring to FIG. 4, the methods described herein help ensure that the thermal margin is maintained at a positive value. The initial portion of the modeling depicted in FIG. 4 is identical to that depicted in FIG. 3 before the event. Further, the percentage of core utilization indicated by line (310) is identical to that depicted in FIG. 3 where the percentage of core utilization shifts from 100% (i.e., all 4 cores (101-1, 101-2, 101-n) active) at the outset to 50% (i.e., 2 cores (101-1, 101-2, 101-n) active) after the event.

However, in instances where the methods described herein are employed, the TDP of the multi-core processor (101) is lowered, which, in turn lowers the total package power (320) from 74 W as depicted in FIG. 3 to 60 W as depicted at the end of line (320) in FIG. 4. Correspondingly, the per-core power (330) is also lowered to 30 W. The cooling fan (121) is then able to catch up with the temperatures of the multi-core processor (101), reducing the temperature, and thus increasing the thermal margin (340). The thermal margin (340), although dipping into negative values at one point, stabilizes at a positive value of approximately 2° C. This all results in lower system noise since the cooling fan (121) is either running slower or not at all, with only slightly lower frequency performance at the lower package power limit.

Various types of workloads may benefit from the methods of instigating the lower package power limit described herein. However, if all cores (101-1, 101-2, 101-n) of the multi-core processor (101) are active, the high-power density situation where all the cores (101-1, 101-2, 101-n) are set to process high loads does not exist within the multi-core processor (101). The methods described herein may be applicable in situations where less than all the cores (101-1, 101-2, 101-n) are active with approximately half the cores (101-1, 101-2, 101-n) active being a situation wherein the multi-core processor (101) may benefit from the methods described herein.

In some situations, the thermal margin may be considered at an acceptable level or within an acceptable range when the active cores (101-1, 101-2, 101-n) are not near each other. In this example, the power density estimate described herein does not calculate for or consider the location of the cores (101-1, 101-2, 101-n) within the multi-core processor (101) or relative to one another. Thus, in some situations such as this example, heat produced through the operation of two cores (101-1, 101-2, 101-n), for example, that are not adjacent to one another may still be able to maintain an acceptable thermal margin. Further, in some situations, the thermal margin may be considered at an acceptable level or within an acceptable range when the multi-core processor (101) includes a high core count. In a high-core-count multi-core processor (101), the cores (101-1, 101-2, 101-n) may have limited core combinations at high loads where cooling becomes an issue. In other words, power density estimates do not consider core locations, and the statistical probability that neighboring cores (101-1, 101-2, 101-n) are operating simultaneously decreases as the number of cores (101-1, 101-2, 101-n) included in the multi-core processor (101) increases.

Further, many computer applications do not draw significant levels of power to be considered high package power. The instruction set of these types of applications being processed will not create a situation where high core power density estimates are present. Further, the present methods may not be suitable in situations where the goal of the user or manufacturer is to lower any effects on processing performance. In one example, a user may be able to select, through a graphical user interface (GUI) for example, whether the present lower package power limiting methods described herein are to be implemented in the course of the data processing performed by the multi-core processor (101). In one example, the user may be allowed to opt into or out of this method of cooling fan (121) control in at least one instance of operating the associated computing device. Thus, adjustment of the processing power of the multi-core processor (101) may result in user dissatisfaction in the response time of the system (100) since the multi-core processor (101) is not processing at a desired level. The option (customer opt-in or opt-out) for quiet performance may be provided to the user to solve customer expectations due to high and/or fluctuating noise.

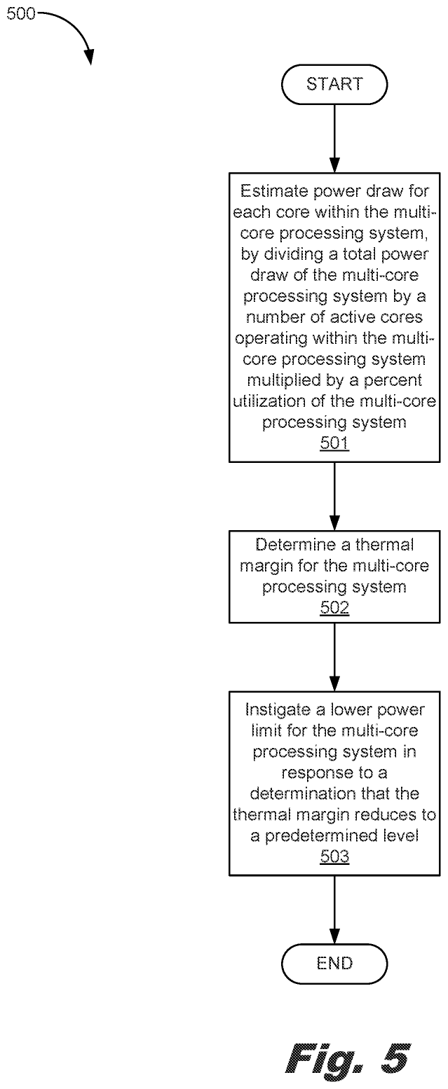

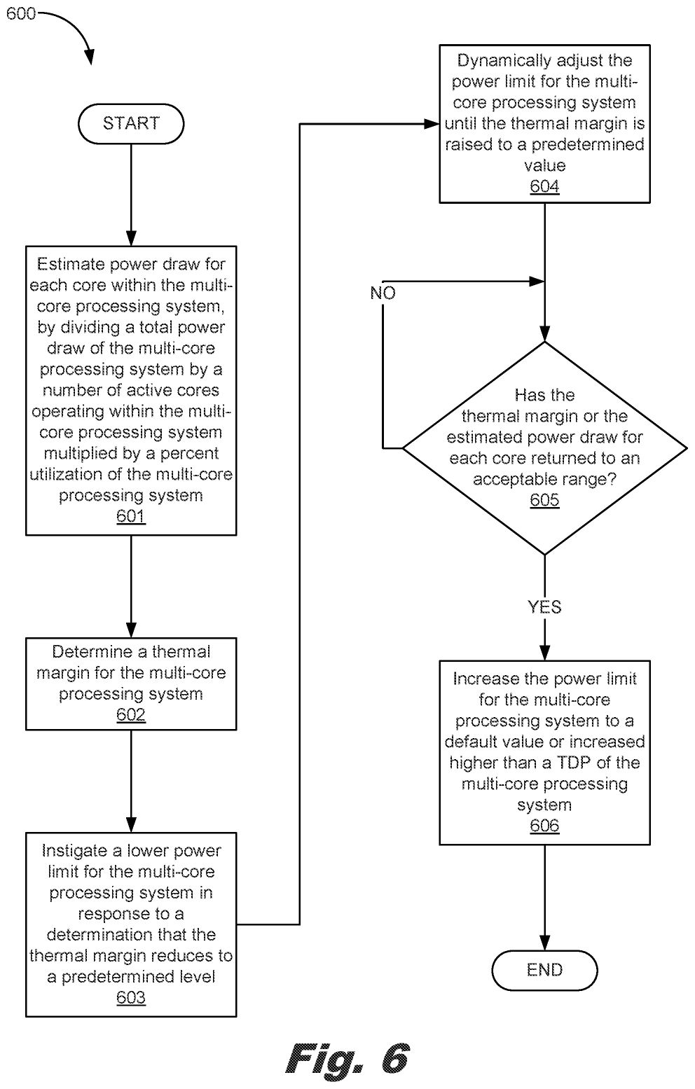

FIG. 5 is a flowchart showing a method (500) of regulating power consumption per core (101-1, 101-2, 101-n) within a multi-core package (101), according to an example of the principles described herein. The method (500) may include estimating (block 501) power draw for each core (101-1, 101-2, 101-n) within the multi-core processing system (100). The power estimation module (115) may be executed to estimate (block 501) power draw for each core (101-1, 101-2, 101-n) by dividing a total power draw of the multi-core processing system (100) by a number of active cores (101-1, 101-2, 101-n) operating within the multi-core processing system (100) multiplied by a percent utilization of the multi-core processing system (100). The power estimation module (115) may also be executed to determine (block 502) a thermal margin for the multi-core processing system (100). The package power limiting module (116) may be executed to instigate (block 503) a lower power limit for the multi-core processing system (100) in response to a determination that the thermal margin reduces to a predetermined level. More details regarding this method is described herein in connection with FIG. 6.

FIG. 6 is a flowchart showing a method (600) of regulating power consumption per core within a multi-core package, according to an example of the principles described herein. The method (600) may include estimating (block 601) power draw for each core (101-1, 101-2, 101-n) within the multi-core processing system (100). The power estimation module (115) may be executed to estimate (block 601) power draw for each core (101-1, 101-2, 101-n) by dividing a total power draw of the multi-core processing system (100) by a number of active cores (101-1, 101-2, 101-n) operating within the multi-core processing system (100) multiplied by a percent utilization of the multi-core processing system (100). The power estimation module (115) may also be executed to determine (block 602) a thermal margin for the multi-core processing system (100). The package power limiting module (116) may be executed to instigate (block 603) a lower power limit for the multi-core processing system (100) in response to a determination that the thermal margin reduces to a predetermined level.

In one example, estimating (block 601) power draw for each core (101-1, 101-2, 101-n) within the multi-core processing system (100) may include correlating power consumption of an active core with a detected temperature of the active cores (101-1, 101-2, 101-n). Thus, the estimated per-core power consumption of the of the cores (101-1, 101-2, 101-n) may be based on the temperature metrics obtained from the individual cores (101-1, 101-2, 101-n) or the multi-core processor (101) as a whole.

The method may also include dynamically (block 604) adjusting the power limit for the multi-core processing system (100) until the thermal margin is raised to a predetermined value. At block 605, it may be determined whether the thermal margin or the estimated power draw for each core (101-1, 101-2, 101-n) has returned to an acceptable value or range. In response to a determination that neither the thermal margin nor the estimated power draw for each core (101-1, 101-2, 101-n) has not returned to an acceptable value or range (block 605, determination NO), the method may loop back to the beginning of block 605 where the determination (block 605) is made again. The loop formed by block 605 may be processed any number of times or iterations until it is determined that either the thermal margin or the estimated power draw for each core (101-1, 101-2, 101-n) has returned to an acceptable value or range (block 605, determination YES). Thus, in response to the determination that either the thermal margin or the estimated power draw for each core (101-1, 101-2, 101-n) has returned to an acceptable value or range (block 605, determination YES), the power limit for the multi-core processing system (100) may be increased (block 606) or returned to a default value. In one example, the default value may be a TDP of the multi-core processing system (100). In one example, the default value may be higher than a TDP of the multi-core processing system in order to maintain performance of the multi-core processing system. Thus, the thermal margin may be set higher than a design limit for all the active cores within the multi-core processing system (100) in order to maintain a desired level of performance of the multi-core processing system (100).

In one example, determining whether the thermal margin or the estimated power draw for each core (101-1, 101-2, 101-n) has returned to an acceptable value or range (block 605) may include determining an acceptable range based on hysteresis of the regulation of the power consumption per core. The metrics stored in the data storage device (102) may be utilized by the multi-core processing system (100) to decrease the number of instances of cycling between application of the relatively lower power level to the multi-core processor (101) and a state where the power level is not adjusted to be reduced.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer-usable program code. The computer-usable program code may be provided to a processor of a general-purpose computer, special purpose computer, or other programmable data processing apparatus to produce a machine, such that the computer-usable program code, when executed via, for example, the multi-core processor (101) of the system (100) or other programmable data processing apparatus, implement the functions or acts specified in the flowchart and/or block diagram block or blocks. In one example, the computer-usable program code may be embodied within a computer-readable storage medium; the computer-readable storage medium being part of the computer program product. In one example, the computer-readable storage medium is a non-transitory computer-readable medium.

The specification and figures describe a method of regulating power consumption per core within a multi-core package may include estimating power draw for each core within the multi-core processing system. Estimating the power draw for each core within the multi-core processing system may include dividing a total power draw of the multi-core processing system by a number of active cores operating within the multi-core processing system multiplied by a percent utilization of the multi-core processing system. The method may include determining a thermal margin for the multi-core processing system, and instigating a lower power limit for the multi-core processing system in response to a determination that the thermal margin reduces to a predetermined level.

The methods and systems described herein assist in ensuring a positive thermal margin within a multi-core processor (101) resulting in a quieter experience for the user as activation of a cooling fan (121) is reduced or largely eliminated.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of regulating power consumption per core within a multi-core package, comprising:
estimating power draw for each core within the multi-core processing system, comprising:
dividing a total power draw of the multi-core processing system by a number of active cores operating within the multi-core processing system multiplied by a percent utilization of the multi-core processing system;
determining a thermal margin for the multi-core processing system;
instigating a lower power limit for the multi-core processing system in response to a determination that the thermal margin reduces to a predetermined level.

2. The method of claim 1, wherein estimating power draw for each core within the multi-core processing system comprises correlating power consumption of an active core with a detected temperature of the active core.

3. The method of claim 1, comprising dynamically adjusting the power limit for the multi-core processing system until the thermal margin is raised to a predetermined value.

4. The method of claim 1, comprising, in response to a determination that the thermal margin or the estimated power draw for each core returns to an acceptable range, increasing the power limit for the multi-core processing system to a default value, increasing the power limit in increments, increasing the power limit to an intermediary value, or combinations thereof.

5. The method of claim 4, wherein the default value is a thermal design power (TDP) of the multi-core processing system.

6. The method of claim 4, comprising determining the acceptable range based on hysteresis of the regulation of the power consumption per core.

7. The method of claim 4, wherein the default value is higher than a thermal design power (TDP) of the multi-core processing system to maintain performance of the multi-core processing system.

8. The method of claim 1, wherein the thermal margin is set higher than a design limit for all the active cores within the multi-core processing system.

9. A non-transitory computer-readable medium comprising computer-usable program code embodied therewith, the computer-usable program code to, when executed by a processor:
estimate power draw for each core within the multi-core processing system, comprising:
divide a total power draw of the multi-core processing system by a number of active cores operating within the multi-core processing system multiplied by a percent utilization of the multi-core processing system;
determine a thermal margin for the multi-core processing system;
instigate a lower power limit for the multi-core processing system in response to a determination that the thermal margin reduces to a predetermined level; and
dynamically adjust the power limit for the multi-core processing system until the thermal margin raised to a predetermined value.

10. The computer-readable medium of claim 9, comprising computer-usable program code to, when executed by the processor, increase the power limit for the multi-core processing system to a default value in response to a determination that the thermal margin or the estimated power draw for each core returns to an acceptable range.

11. The computer-readable medium of claim 9, comprising computer-usable program code to, when executed by the processor, determine the acceptable range based on hysteresis of the regulation of the power consumption per core.

12. The computer-readable medium of claim 10, wherein the default value is a thermal design power (TDP) of the multi-core processing system.

13. The computer-readable medium of claim 10, wherein the default value is higher than a thermal design power (TDP) of the multi-core processing system to maintain performance of the multi-core processing system.

14. A system for regulating power consumption per core within a multi-core package, comprising:
a power estimation module to:
estimate power draw for each core within the multi-core processing system, comprising dividing a total power draw of the multi-core processing system by a number of active cores operating within the multi-core processing system multiplied by a percent utilization of the multi-core processing system; and
determine a thermal margin for the multi-core processing system;
a controller to instigate a lower power limit for the multi-core processing system in response to a determination that the thermal margin reduces to a predetermined level.

15. The system of claim 14, wherein the controller:
dynamically adjusts the power limit for the multi-core processing system until the thermal margin is raised to a predetermined value; and
in response to a determination that the thermal margin or the estimated power draw for each core returns to an acceptable range, increase the power limit for the multi-core processing system to a default value.
